(19) United States
(12) Patent Application Publication
(10) Pub. No.: US 2009/0263010 A1
(43) Pub. Date: Oct. 22, 2009

(54) ADAPTING A PARAMETERIZED CLASSIFIER TO AN ENVIRONMENT

(75) Inventors: Cha Zhang, Sammamish, WA (US); Zhengyou Zhang, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/105,275

(22) Filed: Apr. 18, 2008

(51) Int. Cl. G06F 15/18; G06K 9/62

(52) U.S. Cl. 382/159; 706/12

(57) ABSTRACT

A classifier is trained on a first set of examples, and the trained classifier is adapted to perform on a second set of examples. The classifier implements a parameterized labeling function. Initial training of the classifier optimizes the labeling function's parameters to minimize a cost function. The classifier and its parameters are provided to an environment in which it will operate, along with an approximation function that approximates the cost function using a compact representation of the first set of examples in place of the actual first set. A second set of examples is collected, and the parameters are modified to minimize a combined cost of labeling the first and second sets of examples. The part of the combined cost that represents the cost of the modified parameters applied to the first set is calculated using the approximation function.

### BACKGROUND

Pattern classification is used in machine vision, and other image processing applications, to recognize objects. A classifier takes images as input and applies labels to the images, or to part of the images. For example, a classifier may be able to recognize objects such as a person, a desk, a chair, a window, a face, a nose, etc. Each of the recognizable objects corresponds to a label. The classifier receives an image and applies a label based on its analysis of the image.

The classifier is trained on a set of examples. The examples may take the form of a set of images, with positive or negative labeling information such as “this image is a face” (positive example), or “this image is not a chair” (negative example). The training process “tunes” the classifier in such a way that performs well across the whole set of examples. This tuning may take the form of setting parameters that affect the classifier's behavior. The example set is typically very large, which allows the classifier to be trained to perform well on a wide variety of input. The amount of computational bandwidth involved in training a classifier over a large example set is, likewise, very large. Thus, when a large training set is used, the classifier is normally trained in a production environment, and a trained classifier is delivered to the environment in which it is to be deployed. For example a trained classifier could be deployed in an office or conference room, where it would be used to recognize people in the room. Since the training has already taken place before the classifier is deployed, the examples normally are not delivered with the classifier, and there is normally no reason for the classifier to expend computational bandwidth to retrain on these examples after the classifier has been deployed.

When the classifier has been deployed in a particular environment, the visual input to the classifier tends to be narrower than the training examples. For example, the objects in an office, and the people who move in and out of the office, may not change much over time. A classifier may be able to perform in the operating environment in which it has been deployed using its training on a generic example set. However, a classifier trained on generic examples may not perform as well, in certain contexts, as a classifier that has been trained to respond to its specific environment. Classifier adaptation techniques typically have not focused on adapting an existing classifier, trained on generic examples, to a specific environment. If adaptation would involve running the training process on both the generic and new examples in the deployment environment, then large amounts of storage space and computational bandwidth would be used to store the original generic examples and to retrain the classifier on those examples during adaptation. In this case, adaptation of the classifier after deployment of the classifier may not be practical.

### SUMMARY

A classifier that has been trained on a generic set of examples may be adapted for use in a particular environment. The classifier implements a labeling function that assigns a label to a particular input. The labeling function has a set of parameters that define how various feature of the input are to be interpreted. For example, the parameters may define how much sharpness a line would have in order to be recognized as a line, how much brightness a region would have in order to be recognized as white, etc. A cost function is defined that determines the cost of using the labeling function with a particular set of parameters. The incorrect labeling of an object is one example of a cost, although any type of cost (e.g., computational inefficiency, memory usage, etc.) could be recognized by the cost function. The classifier may be trained on the examples in order to choose parameters that minimize the cost function. A trained classifier, including the labeling function with the chosen parameters, is delivered to the environment in which the classifier is to be deployed.

During operation of the classifier, new examples may be obtained. For example, a person could provide an image and explicitly label the image for the classifier (e.g., “this is an image of me”). The classifier may be trained on the new examples in order to find a new set of parameters that minimizes cost over both the old and new examples. The cost may be calculated as a weighted sum of the cost functions over the old and new examples. The cost function over the old examples may be calculated using an approximation that is computable over a new set of parameters, without using the full set of original examples. Such an approximation may be calculable in the environment in which the classifier has been deployed, even if the original set of examples on which the classifier was trained are not available as input to the cost function. One example of an approximation of the cost function is an n^{th} order Taylor expansion of the cost function that uses a Hessian matrix and a gradient derived from the original cost function as coefficients, although any approximation could be used.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example adaptable classifier.

FIG. 2 is a flow diagram of an example process in which a classifier is trained, adapted, and/or used.

FIG. 3 is a flow diagram of an example process of adapting a classifier's parameters.

FIG. 4 is a flow diagram of an example process of generating similarity examples.

FIG. 5 is a block diagram of example components that may be used in connection with implementations of the subject matter described herein.

### DETAILED DESCRIPTION

Pattern classification may be used to recognize objects. A classifier is a component that recognizes objects in an image and applies labels to the image or to parts thereof. For example, if a particular part of the image is a person, a face, a dog, a potted plant, or any other type of recognizable object, the classifier attempts to discern what the object is, and applies a label. The label chosen by the classifier may be used as input to any application that responds to visual input as a stimulus. Machine vision is one example of an application that may make use of the labels provided by a classifier, although various types of applications could make use of this information. In general, any type of content item—image, audio, handwriting, etc.—could be subject to a classification process.

A classifier may implement a mapping, or labeling, function, which takes an image as input and provides a label as output. The labeling function may be parameterized, so that the function can be “tuned” by changing the parameters. The values of the parameters may affect the ways in which the function analyzes its input. For example, the labeling function may attempt to discern particular objects within an image by looking for contrast among different regions, sharp lines, particular colors, or any other feature. Thus, the parameters may define how much sharpness a line would have in order to be recognized as a line, how much brightness a region would have to be in order to be recognized as white, how much contrast between different regions suggests that the regions contain different objects, etc. The classifier may be trained on a set of examples, in order to find a set of parameters that are optimal for the labeling function.

In order to find the optimal parameters, a cost function may be defined. The cost function accounts for some type of effect of applying the function to a particular set of input with a particular set of parameters. Applying the wrong label to an input is one example of a cost (e.g., if the parameters are set in to particular values and generate a large number of mislabeled examples, then that set of parameter values may be said to have a high cost). However, the cost function could recognize any other type of effect (e.g., computational inefficiency, memory usage, etc.) as a cost. The optimal parameters are the parameters that minimize the cost function over some set of input. There are various algorithms to find the parameters that minimize the cost function for a given input. When these algorithms are run over a training set, the result is a set of parameters that optimize the behavior of the labeling function over the set of training examples. For example, if the cost function considers an incorrect label to be a cost, then minimizing the cost function over the set of training examples results in a set of parameters that performs well at labeling the examples.

A set of training examples may be chosen to represent a wide variety of input. Thus a classifier with parameters that have been optimized for the training examples may be expected to perform well in a variety of environments. However, when the classifier is deployed in an actual operating environment, the range of input may be relatively small. For example, if the classifier is deployed in a person's office, the color of the walls, the furniture, the lighting conditions, and even the people seen in the office may remain largely the same. Thus, the classifier could be adapted to perform well in the environment in which the classifier is deployed.

Examples may be collected in the environment in which the classifier is deployed. A person could explicitly provide labels of examples (e.g., “This is an image of me”). However, since this labeling process is expensive for a user in terms of time and effort, the number of examples collected in the deployment environment is expected to be small. The small number of examples makes it difficult to operate a classifier that is trained solely on examples derived from its operating environment. Therefore, there may be reason for a classifier to be able to benefit from its training on generic examples, while also being adapted based on examples from the environment in which it is deployed.

The naïve way to train a classifier both on generic and environment-specific examples is to aggregate the examples and to train the classifier on the aggregate set. Thus, if there are, say, one million generic examples and one hundred environment-specific examples, the training process, in theory, could be run on the 1,000,100 aggregate examples to optimize the labeling function's parameters for those examples. However, performing this training would involve running the cost minimization algorithm on the labeling function over all 1,000,100 examples. This would involve having access to both (a) the generic examples and the environment-specific examples, and (b) sufficient bandwidth to run the optimization algorithm. Typically, training on the generic examples is performed in a production environment in order to create a trained classifier that may be deployed in an operating environment—without having to expend bandwidth in the operating environment to train the classifier. Because the training set is large, the training set typically is not provided to the classifier's operating environment. Moreover, since environment-specific examples may be generated at various times, optimizing the parameters for new environment-specific examples would involve running the cost minimization algorithm on the generic examples and environment-specific example each time the classifier is to be adapted to new examples. This approach is not practical.

The subject matter described herein may be used to adapt a generically-trained classifier. Assuming that there is a cost function that calculates the cost of using a particular set of parameters for the labeling function, an approximation of this cost function may be created. The approximation of the cost function is itself a function, and this approximation function uses a compact representation of the training example set on which the cost function is calculated. The cost of using a particular set of parameters to label the generic training examples, and any new examples derived from the classifier's operating environment, may be calculated as the sum of the approximated cost function over the generic examples, and a cost function calculated over the new examples. The addends in the sum may be weighted to reflect the relative influences of the costs that the generic and new (environment-specific) examples contribute to the final cost calculation. Using an approximation of the cost function over the generic examples allows the generic examples to be taken into account when calculating the (approximate) cost of various parameter settings, and allows this calculation to be made without having to apply the cost function to the whole set of generic examples. One example of an approximation of the cost function is the n^{th} order Taylor expansion of the original cost function (e.g., n=2), although any type of approximation could be used.

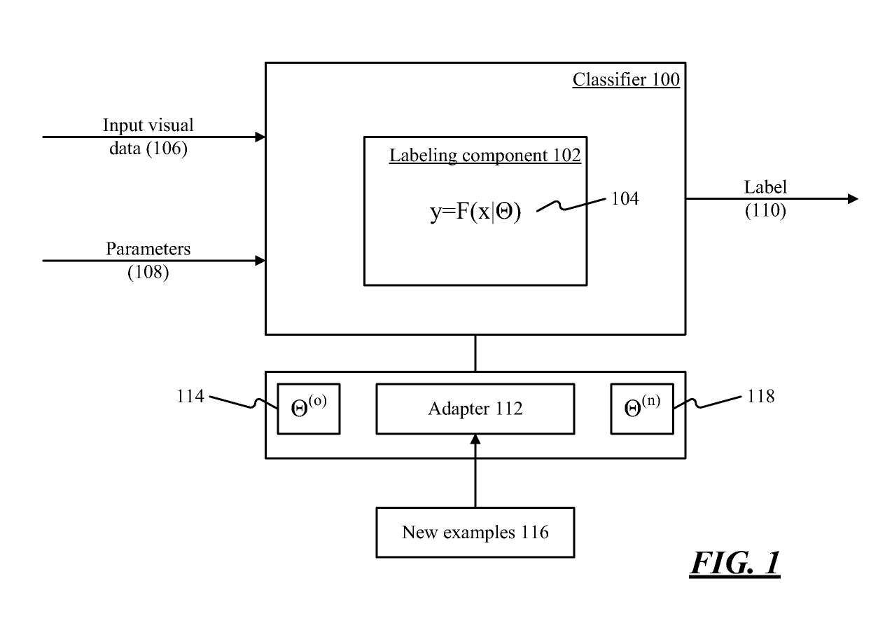

Turning now to the drawings, FIG. 1 is a block diagram of an example classifier 100. Classifier 100 comprises, or otherwise makes use of, a labeling component 102, which implements a labeling function 104. Labeling function 104 may be described as

y=F(x|Θ), (1)

where x is the input, Θ is a set of parameters, and F is a function that generates a label, y, based on the input and the parameters. As shown in the drawings, classifier 100 receives input visual data 106 (or some other input item), and parameters 108. The variable x in equation (1) comprises, or is derived from, input visual data 106; Θ corresponds to parameters 108; and F corresponds to labeling function 104. y is the label that results from applying F to x and Θ, and this label 110 is provided as the output of classifier 100.

Classifier 100 may comprise, or otherwise make use of, an adapter 112, which adapts classifier 100 based on new information. For example, as previously discussed, a classifier that is trained on generic examples may be adapted based on environment-specific examples. Adapter 112 may perform this adaptation process by modifying the parameters Θ used by labeling function 104. For example, training classifier 100 on a set of generic examples results in parameters Θ^{(o)} (block 114). Adapter 112 may take the original parameters and a set of new examples 116, and may generate a new set of parameters Θ⁽ⁿ⁾ (block 118) that optimizes the cost function over both the generic and new examples. Labeling function 104 may then use parameters Θ⁽ⁿ⁾ when it receives input images to label.

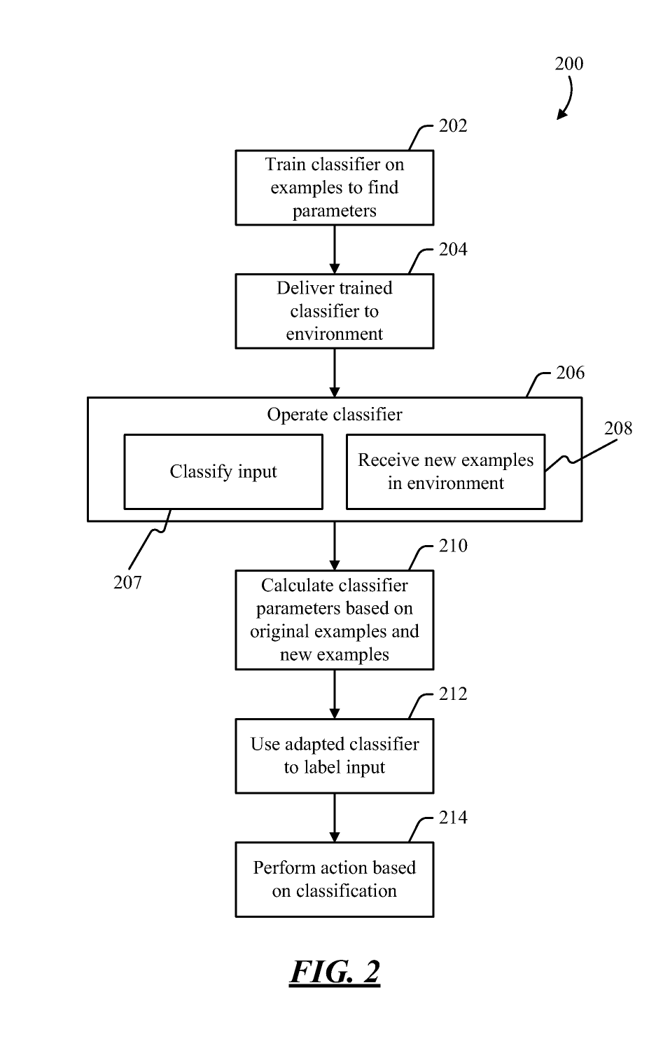

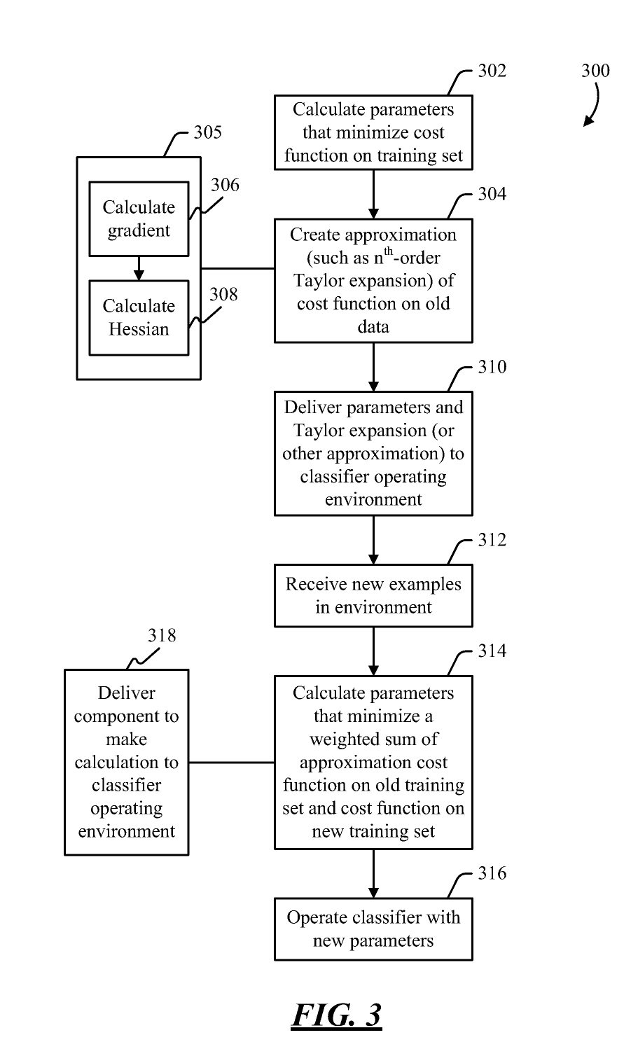

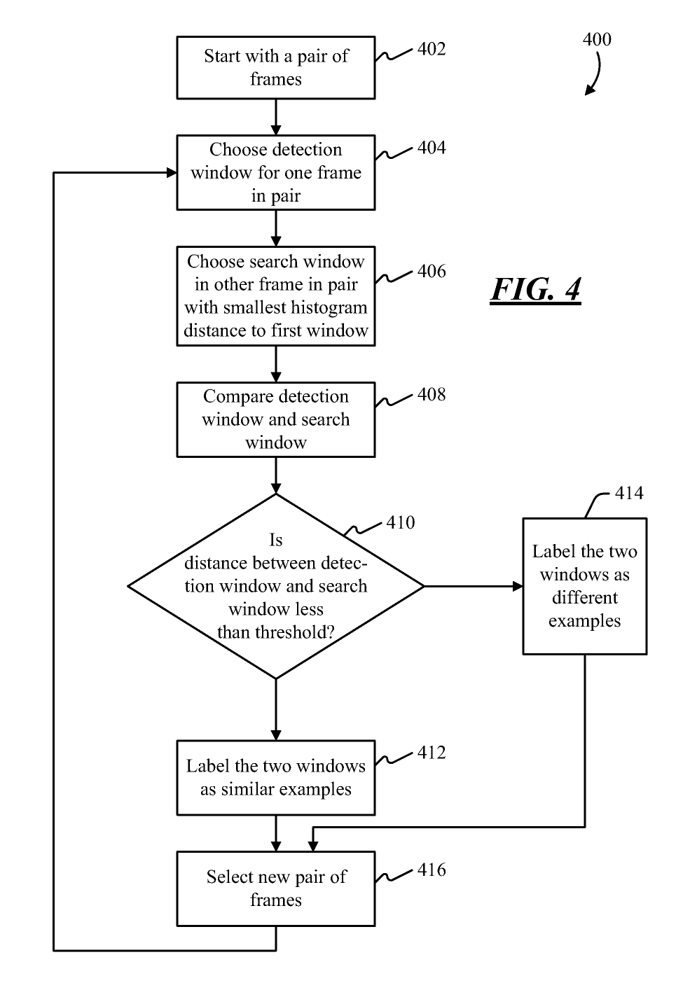

FIG. 2 shows an example process 200 in which a classifier is trained on a set of examples, adapted to additional examples, and used to classify input. The flow diagram in FIG. 2, as well as those shown in FIGS. 3-4, show examples in which stages of a process are carried out in a particular order, as indicated by the lines connecting the blocks, but the various stages shown in these diagrams can be performed in any order, or in any combination or sub-combination.

At 202, a classifier is trained on a set of examples to find a set of parameters. For example, a cost function may be defined, and a set of parameters may be found to minimize the cost function over a set of training examples. Examples may take any form. In one case, examples comprise a set, S, of image/label pairs, where each pair is indicated as being either a positive or negative example. (“This image is a dog” is a positive example; “this image is not a cat” is a negative example.) These positive or negative examples are referred to as direct examples, since they directly define what is a correct or incorrect label for an image. Another type of example is a similarity example. A set, S, of similarity examples comprises pairs of images along with an indication of whether or not the images in the pair have the same label. Thus, these types of examples take the form of “these two images have the same label”, or “these two images do not have the same label”. In contrast to direct examples, similarity examples may not specify the actual label that that the images do (or do not) share.

Regardless of the form that the examples take, the labeling function of equation (1), above, may be tested against the examples by applying the function to images and to some set of parameters (Θ), to see if the labeling function labels the examples correctly. A cost function, C, may be defined as

C(F(x|Θ),S), (2)

which calculates the cost of using F to label set S. (As noted above, the cost calculated by function C could be a measure of how many examples F mislabels on a given input, although any type of cost could be calculated.) The parameters, Θ, that minimize C over set S may be found. Algorithms to find parameters that minimize the cost function are generally known. Performing training over set S may result in a set of parameters that are optimized for S. If S is a large set of generic examples, then the result of the training process may be a trained classifier that is able to recognize and label a wide variety of inputs.

At 204, the trained classifier is delivered to an environment in which it will operate. This delivery could take any form. For example, the classifier may be a program, or a component of a program, that runs on a general-purpose computer, in which case delivery of a trained classifier may involve installing the program or component on the computer. As another example, the trained classifier may be a stand-alone piece of hardware (e.g., a box that has a camera and a classifier program), in which case delivery of the classifier involves delivering the box to its operating environment.

At 206, the classifier is operated in its operating environment. Operating the classifier may involve classifying visual input that is received (at 207). As part of operating the classifier, new examples may also be received (at 208). For example, a person could provide an image and a label to the classifier, or the classifier could select an image and ask the person to provide a label. The classifier could also use its input to generate a set of similarity examples, using a method that is described below in connection with FIG. 4.

At 210, the classifier parameters may be calculated based on the original examples and the new examples. The adjustment of the parameters represents the adaptation of the classifier to the new environment, and this adaptation may be performed as follows.

During initial training, a classifier is trained on a large data set, which may be represented by S^{(o)}. The classifier may be denoted by its labeling function, F(x|Θ^{(o)}). In both S^{(o)} and Θ^{(o)}, the superscript (o) refers to the “old” data set. Thus, S^{(o)} refers to the original (old) training data set, and Θ^{(o)} refers to parameters that have been optimized for the data set S^{(o)}. Adaptation of the classifier takes into account a data set S⁽ⁿ⁾ (where the superscript (n) refers to the “new” data set). Data set S⁽ⁿ⁾ may, for example, contain examples that have been provided by a user of the classifier. For example, S⁽ⁿ⁾ may contain examples that have been labeled by the user, and the classifier may be trained on these examples. An adaptation process attempts to find a new set of parameters, Θ⁽ⁿ⁾, which takes into account the new examples, and may allow the classifier to label object more reliably in the operating environment.

One way to calculate the new parameters, Θ⁽ⁿ⁾ is to find

$$\begin{matrix}{Θ}^{( n )} = {arg min}_{Θ} J ( Θ ) \\ = {arg min}_{Θ} ( C ( F ( x \vert Θ ) , {𝒮}^{( o )} ) + λ D ( F ( x \vert Θ ) , {𝒮}^{( n )} ) ) ,\end{matrix} \qquad ( 3 )$$

where J is the revised overall cost function for adaptation, D is a cost function defined on the new data set S⁽ⁿ⁾, and λ is a factor by which one of the cost functions is multiplied to control the relative importance of the old and new data sets. J is thus a weighted sum of a cost function calculated over the old data set and a cost function calculated over the new data set, using the same parameters in each addend in the weighted sum. The cost functions calculated over both the old and new data sets may be the same function. However, for generality, they are written in equation (3) as the separate functions C and D, since the labels in S^{(o)} and S⁽ⁿ⁾ could be in different forms. (E.g., S^{(o)} might contain direct examples and S⁽ⁿ⁾ might contain similarity examples, or vice versa.)

Calculating the C(F(x|Θ),S^{(o)}) component of equation (3) involves having access to the data set S^{(o)} (which could be very large), and performing an intensive calculation over this large data set. Thus, one way to calculate Θ⁽ⁿ⁾ (which, as described above in equation (3), might involve calculating C), is to use an approximation of C,

C(F(x|Θ),S^{(o)})≈\tilde{C}(F(x|Θ), [symbol] (S^{(o)})), (4)

where [symbol] (S^{(o)}) is a compact representation of the old data set, and \tilde{C} is a function that approximates C by using this compact representation. One example of \tilde{C} is a Taylor expansion of C, in which [symbol] (S^{(o)}) comprises the gradient and Hessian of C(F(x|Θ),S^{(o)}):

$$C ( F ( x \vert Θ ) ) \approx C ( F ( x \vert {Θ}^{( o )} ) ) + ∇ C ( F ( x \vert {Θ}^{( o )} ) ) ( Θ - {Θ}^{( o )} ) + \frac{1}{2} {( Θ - {Θ}^{( o )} )}^{T} {H}_{C} ( {Θ}^{( o )} ) ( Θ - {Θ}^{( o )} ) . \qquad ( 5 )$$

(In equation (5), and in the equations below, Θ is represented in vector form, T stands for vector transpose, and, for conciseness, the symbol S^{(o)} is omitted from C's argument list.) \tilde{C} is shown in the foregoing example as being based on both the original cost function C, as well as on the compact representation, [symbol] (S^{(o)}), of the original training set. However, \tilde{C} could be based on one of these items but not the other. For example, one could use the compact representation [symbol] (S^{(o)}), during adaptation, with the original cost function instead of with the Taylor expansion.

In equation (5), ∇C(F(x|Θ^{(o)})) is the gradient of the cost function C, and H_{C}(Θ^{(o)}) is the Hessian matrix whose elements comprise the second order derivative of the cost function with respect to Θ. The size of gradient vector ∇C(F(x|Θ^{(o)})) and Hessian matrix H_{C}(Θ^{(o)}) are together likely to be much smaller than the size of S^{(o)}, thereby allowing an approximation of C to be calculated without providing the full set S^{(o)} to the environment in which the classifier is to be adapted. In equation (5), the right-hand side of the ≈ is a second-order Taylor expansion. This approximation of C is valid for smooth multivariate functions where ∇C(F(x|Θ^{(o)})) and H_{C}(→^{(o)}) exist within a ball in the space of Θ with center at Θ^{(o)}. It is noted that C could be approximated in some other way, such as by an n^{th} order Taylor expansion, or by another type of function.

The approximation of C, as shown in equation (5), may be used to calculate J in equation (3). This calculation may be used to find parameters Θ⁽ⁿ⁾ that minimize the cost J over a combination of old and new examples, S^{(o)} and S⁽ⁿ⁾. The use of this approximation technique could be used to adapt various types of classifiers. The following shows how this technique could be used to adapt a logistic regression classifier or a boosting classifier.

In logistic regression, a set of features fⱼ(•), j=1, . . . , J are extracted from a training data set S={(xₖ, tₖ), k=1, . . . , K}, where xₖ is a labeled example, and tₖ is 1 for positive examples and 0 for negative examples. The likelihood of an example being a positive example is:

$${p}_{k} = \frac{1}{1 + exp \{ - {\sum }_{j} {w}_{j} {f}_{j} ( {x}_{k} ) \}} , \qquad ( 6 )$$

where wⱼ is the set of parameters to be determined, and exp {x} is a notation standing for raising the transcendental number e to the power x. The likelihood function of the whole data set can be written as:

$$P = {\prod }_{k}^{ } {{p}_{k}^{{t}_{k}} ( 1 - {p}_{k} )}^{1 - {t}_{k}} . \qquad ( 7 )$$

A cost function may be defined by taking the negative logarithm of the likelihood, which gives the cross-entropy error function as:

$$C {=}^{Δ} - \frac{1}{K} ln P = - \frac{1}{K} {\sum }_{k} \{ {t}_{k} ln {p}_{k} + ( 1 - {t}_{k} ) ln ( 1 - {p}_{k} ) \} . \qquad ( 8 )$$

Logistic regression minimizes the cost function in equation (8) on a training data set to find the optimal set of parameters wⱼ. Algorithms to solve logistic regression are generally known.

A logistic regression classifier may be adapted using the techniques previously discussed above. The gradient and Hessian of the logistic regression error function with respect to the parameters wⱼ may be calculated as:

$$\begin{matrix}\frac{\partial C}{\partial {w}_{j}} = \frac{1}{K} {\sum }_{k} ( {p}_{k} - {t}_{k} ) {f}_{j} ( {x}_{k} ) . & ( 9 ) \\ \frac{{\partial }^{2} C}{\partial {w}_{i} \partial {w}_{j}} = \frac{1}{K} {\sum }_{k} {p}_{k} ( 1 - {p}_{k} ) {f}_{i} ( {x}_{k} ) {f}_{j} ( {x}_{k} ) . & ( 10 )\end{matrix}$$

The parameter vector may be denoted as w=[w₁, . . . , wⱼ]^{T}. The likelihood and label vectors of all examples may be denoted as p=[p₁, . . . , p_{K}]^{T} and t=[t₁, . . . , t_{K}]^{T}. F may denote the K×J design matrix with fⱼ(xₖ) as the (k, j)^{th} element. Thus, in vector form:

$$∇ C ( w ) = \frac{1}{K} {F}^{T} ( p - t ) \\ {H}_{C} ( w ) = ∇ ∇ C ( w ) = \frac{1}{K} {F}^{T} RF , \qquad ( 11 )$$

where R is the K×K diagonal weighting matrix with elements Rₖₖ=pₖ(1−pₖ).

As discussed above, a cost function on the training data set may be approximated. For logistic regression, this function may be approximated as follows:

$$C ( w ) \approx C ( {w}^{( o )} ) + ∇ C ( {w}^{( o )} ) ( w - {w}^{( o )} ) + \frac{1}{2} {( w - {w}^{( o )} )}^{T} {H}_{C} ( {w}^{( o )} ) ( w - {w}^{( o )} ) , \qquad ( 12 )$$

where ∇C(w^{(o)}) and H_{C}(w^{(o)}) are computed at the generic classifier's weight vector w^{(o)} on the old data set. With this approximation of C, equation (3), discussed above, may be used to find parameters that minimize the cost function over the training examples and any additional examples collected in the operating environment.

The examples collected in a classifier's operating environment, which are used to adapt the classifier, may be examples with direct or similarity labels. The following explains how a logistic regression classifier may be adapted based on both kinds of labels.

Direct labels are labels of the form

$${𝒮}^{( n )} = \{ ( {x}_{k}^{( n )} , {t}_{k}^{( n )} ) , k = 1 , … , {K}^{( n )} \} ,$$

where xₖ⁽ⁿ⁾ is an example, and tₖ⁽ⁿ⁾ is the label on the example. (As before, the superscript (n) indicates expressions that relate to the “new” data collected in the operating environment.) The cost function on the new data set may be analogous to the cross-entropy error function defined in equation (8):

$$D {=}^{Δ} - \frac{1}{{K}^{( n )}} {\sum }_{k} \{ {t}_{k}^{( n )} ln {p}_{k}^{( n )} + ( 1 - {t}_{k}^{( n )} ) ln ( 1 - {p}_{k}^{( n )} ) \} , \qquad ( 13 )$$

where pₖ⁽ⁿ⁾ is defined above in equation (6). The overall cost function for classifier adaptation, in this example, is thus:

$$J ( w ) = C ( {w}^{( o )} ) + ∇ C ( {w}^{( o )} ) ( w - {w}^{( o )} ) + \frac{1}{2} {( w - {w}^{( o )} )}^{T} {H}_{C} ( {w}^{( o )} ) ( w - {w}^{( o )} ) + λ D ( w ) . \qquad ( 14 )$$

The overall cost function may be minimized by an efficient iterative technique based on the Newton-Raphson iterative optimization scheme. The iterative technique takes the form:

w^{[i+1]}=w^{[i]}−H_{J}⁻¹(w^{[i]})∇J(w^{[i]}), (15)

where i is the iteration index. The following may be calculated:

∇J(w^{[i]})=H_{C}(w^{(o)})(w^{[i]}−w^{(o)})+∇C(w^{(o)})+λ∇D(w^{[i]}),

H_{J}(w^{[i]})=H_{C}(w^{(o)})+λH_{D}(w_{[i]}), (16)

where the gradient and Hessian of the error function D(w) on the new data set can be calculated as in equation (11).

During the iterative optimization process, the weight vector of the generic classifier is used for initialization:

w^{[0]}=w^{(o)} (17)

Iteration may then be performed on equation (15) until the Newton decrement is less than a certain threshold ξ:

\sqrt{∇J(w^{[i]})^{T}H_{J}⁻¹(w^{[i]})∇J(w^{[i]})}<ξ. (18)

As an alternative to adaptation using direct labels (as described above), adaptation may be performed using similarity labels, which indicate whether two examples share the same direct label (but may not explicitly specify what that direct label is). Similarity labels may take the form of

$${𝒮}^{( n )} = \{ ( {x}_{k 1}^{( n )} , {x}_{k 2}^{( n )} , {z}_{k}^{( n )} ) , k = 1 , … , {K}^{( n )} \} ,$$

where xₖ₁⁽ⁿ⁾ and xₖ₂⁽ⁿ⁾ are the two examples, zₖ⁽ⁿ⁾=1 indicates that the two examples are to have the same label, and zₖ⁽ⁿ⁾=0 indicates the two examples are to have different labels. In the following explanation, the superscript (n) is omitted for conciseness.

With similarity examples, the probability of xₖ₁ and xₖ₂ sharing the same label can be written as:

$$\begin{matrix}{p}_{k} = {p}_{k 1} {p}_{k 2} + ( 1 - {p}_{k 1} ) ( 1 - {p}_{k 2} ) , \\ where & ( 19 ) \\ {p}_{kl} = \frac{1}{1 + exp \{ - {\sum }_{j} {w}_{j} {f}_{j} ( {x}_{kl} ) \}} , l ∈ 1 , 2. & ( 20 )\end{matrix}$$

The cross-entropy error function is:

$$D {=}^{Δ} - \frac{1}{K} {\sum }_{k} \{ {t}_{k} ln {p}_{k} + ( 1 - {t}_{k} ) ln ( 1 - {p}_{k} ) \} . \qquad ( 21 )$$

In the case of similarity examples, the Newton-Raphson method may be used to find the optimal parameter vector, as in equations (15) and (16), except that the gradient and Hessian of the cost function on the new data sets is revised. In the case of similarity examples, the gradient of the cost function on the new data set is:

$$\begin{matrix}\frac{\partial D}{\partial {w}_{j}} = \frac{1}{K} {\sum }_{k} \frac{( {p}_{k} - {z}_{k} ) {g}_{jk}}{{r}_{k}} , \\ where \\ {r}_{k} = {p}_{k} ( 1 - {p}_{k} ) , \\ {g}_{jk} = \frac{\partial {p}_{k}}{\partial {w}_{j}} = - {q}_{k 2} {r}_{k 1} {f}_{j} ( {x}_{k 1} ) - {q}_{k 1} {r}_{k 2} {f}_{j} ( {x}_{k 2} ) , \\ with \\ {r}_{kl} = {p}_{kl} ( 1 - {p}_{kl} ) , \\ {q}_{kl} = \frac{\partial {r}_{kl}}{\partial {p}_{kl}} = 1 - 2 {p}_{kl} , l ∈ \{ 1 , 2 \} . \\ Second order derivatives are \text{:} & ( 22 ) \\ \frac{{\partial }^{2} D}{\partial {w}_{i} \partial {w}_{j}} = \frac{1}{K} {\sum }_{k} \{ \frac{[ {p}_{k}^{2} + {z}_{k} {q}_{k} ] {g}_{jk} {g}_{ik}}{{r}_{k}^{2}} + \frac{( {p}_{k} - {z}_{k} ) {h}_{ijk}}{{r}_{k}} \} , \\ where \\ {q}_{k} = \frac{\partial {r}_{k}}{\partial {p}_{k}} = 1 - 2 {p}_{k} , \\ \begin{matrix}{h}_{ijk} = \frac{\partial {g}_{jk}}{\partial {w}_{i}} \\ = 2 {r}_{k 1} {r}_{k 2} [ {f}_{i} ( {x}_{k 1} ) {f}_{j} ( {x}_{k 2} ) + {f}_{i} ( {x}_{k 2} ) {f}_{j} ( {x}_{k 1} ) ] - \\ {q}_{k 1} {q}_{k 2} [ {r}_{k 1} {f}_{i} ( {x}_{k 1} ) {f}_{j} ( {x}_{k 1} ) + {r}_{k 2} {f}_{i} ( {x}_{k 2} ) {f}_{j} ( {x}_{k 2} ) ] .\end{matrix} & ( 23 )\end{matrix}$$

The Hessian matrix for similarity labels on the new data set is not necessarily positive definite, so optimizing the error function D(w) on the new data set alone may not provide a global minimum. However, w^{(o)} is the global optimal estimate minimizing the error function on the old data set, and thus may be used as an initial estimate in the optimization algorithm.

As noted above, a logistic regression classifier is one type of classifier that may be adapted using the techniques described herein. A boosting classifier is another example of such a classifier. In a boosting classifier, each example may be classified by a linear combination of weak classifiers. Given a test example, xₖ, the score of the example is a weighted sum of weak classifiers hⱼ(•), i.e.,

$${s}_{k} = {\sum }_{j} {a}_{j} {h}_{j} ( {x}_{k} ) \qquad ( 24 )$$

where hⱼ(xₖ) can be written as:

$${h}_{j} ( {x}_{k} ) = \{ \begin{matrix}+ 1 , & if {h}_{j} ( {x}_{k} ) > {t}_{j} \\ - 1 , & otherwise\end{matrix} \qquad ( 25 )$$

where tⱼ is the threshold for weak classifier hⱼ(•). The final decision is made by comparing the example's score with an overall threshold T. That is, if sₖ>T, then example xₖ is a positive example; otherwise xₖ is a negative example.

There are various approaches for boosting classifier learning, which are generally known. In one such approach (known as “AnyBoost”), boosting may be viewed as a gradient-descent algorithm in the function space. In such an approach, the probability of an example being positive may be described as:

$${p}_{k} = \frac{1}{1 + exp \{ - {s}_{k} \}} \qquad ( 26 )$$

A gradient-descent process may be used to search for the weak classifiers hⱼ(•) and weights aⱼ with the same cost function as in equation (8).

If, in the above-described AnyBoost formulation, the search for adapted parameters is limited to updating the weights, aⱼ, the adaptation of a boosting classifier may be the same as the adaptation of a logistic regression classifier. The difference between these adaptation processes would be that, in logistic regression, the features fⱼ(•) are normally real-valued, while in a boosting classifier the weak classifiers hⱼ(•) are binary.

The foregoing provides a description of example of how adaptation of a classifier (at 210 in FIG. 2), may be performed. Continuing with process 200 of FIG. 2, at 212 the adapted classifier may be used to label input. For example, images in the classifier's operating environment may be received through a camera, and the adapted classifier may be used to classify the input.

At 214, an action may be performed based on the classification generated by the classifier. For example, the classifier may provide a label to some type of component (such as a hardware or software component). The component may then use the label as a basis to perform an action. Any type of action could be performed. For example, the classifier could label live video input as containing the image of a person. This label could be provided to a component which could then generate an audio greeting (e.g., “hello”). Or the label could indicate not only that the images being received contain a person, but that the person has a specific identity, in which case the component could generate a more specific greeting (e.g., “hello, Fred”). Other examples of actions are also possible. For example, a classifier could be placed in a conference room. The classifier could identify the people attending a particular conference, and a system, in conjunction with a voice recognizer, could generate a transcript of the conference indicating who said what. These are some examples of tangible actions that could be performed based on the labels provided by a classifier, although any type of action could be performed.

As discussed above in connection with 210 of FIG. 2, a classifier with parameters trained on a set of examples may be adapted to a specific operating environment. Processes for performing this adaptation with various types of classifiers are described above using equations. However, FIG. 3 shows, in the form of a flowchart, an example process 300 of adapting a classifier's parameters.

At 302, a classifier is trained on a training data set to calculate parameters that minimize the cost function on this training data set. The search for parameters may be performed, for example, by minimizing expression (2).

At 304, a Taylor expansion of the cost function on the training data set (or some other approximation of the cost function) is created. The Taylor expansion may contain a compact representation of the training data set. As part of the process of creating the Taylor expansion, a compact representation of the cost function may be calculated (at 305). Calculating this compact representation may comprise, for example, calculating the gradient and Hessian of the cost function on the training set (at 306 and 308, respectively). In one example, the Taylor expansion that is used is a second-order Taylor expansion, although any finite-order Taylor expansion could be used. Moreover, the gradient and Hessian matrix describe above are examples of constructs that could be used as compact representations of the training data set, although any other representation could be used (or these constructs could be used in some context other than a Taylor expansion).

At 310, the Taylor expansion (or other approximation of the cost function), as well as the parameters that were created at 302, are delivered with the classifier to the classifier's target operating environment. In that operating environment, the classifier may receive new examples (at 312). For example, the classifier may receive labeled images (e.g., a user may provide an explicit label for an image). Or, examples could be generated from input, using, for example, the process described below in connection with FIG. 4.

Regardless of how the examples are received, parameters may be calculated (at 314) that minimize a weighted sum of (a) the n^{th} order Taylor expansion (or other approximation) of the cost function on the original training set, and (b) a cost function calculated on the new examples. (Equation (3) above is an example of such a weighted sum.) A component that makes this calculation may be delivered to the classifier's operating environment (block 318). Equations (3) through (26), listed and explained above, describe example ways of calculating these cost functions and finding the parameters that minimize the cost.

At 316, the classifier is operated to perform labeling of input, using the new parameters.

As noted above, examples could be manually generated by a person (e.g., by providing an image and indicating the appropriate label for the image), or examples could be generated algorithmically from a set of input. FIG. 4 shows an example process 400 that may be used to generate similarity examples.

At 402, the process starts with a pair of input frames—e.g., two frames of video input. At 404, a detection window is chosen for one of the frames (the “first frame”) in a pair. At 406, a search window is chosen in the other frame (the “second frame”) in the pair. The search window is chosen to be a window in the second frame that has the same size as the detection window chosen in the first frame, and the smallest histogram distance to that detection window. The histogram of the first window may be described as p={p(u), u=1, . . . , m}. The histogram of the second window may be described as q={q(u), u=1, . . . , m}. In both histograms, m is a number of bins. The distance between two discrete distributions is defined as

$$\begin{matrix}d = \sqrt{1 - ρ [ p , q ]} , \\ where & ( 27 ) \\ ρ [ p , q ] = {\sum }_{u = 1}^{m} \sqrt{p ( u ) q ( u )} & ( 28 )\end{matrix}$$

is the sample estimate of the Bhattacharyya coefficient between p and q. In greater generality, any tracking algorithm may be used to choose the search window.

When the pair of windows has been chosen, the histogram distance is compared (at 408). If (as determined at 410) the histogram distance between the windows is less than a threshold, d, then the windows are labeled (at 412) as similar examples (that is, the windows form a similarity example of two images that share the same label). If the distance exceeds threshold d, then the windows are labeled (at 414) as non-similar examples (that is, as forming a similarity example of two images that do not share the same label). If the examples are considered similar, then a similarity example may be generated that contains the two windows and a positive similarity indication. Any value may be chosen for the threshold, d. In one example, d=0.03. After the labeling, a new pair of frames is selected (at 416), and the process returns to 404 to consider the new pair of frames. In greater generality, any distance measure could be used to compare the two windows, of which histogram distance is merely one example.

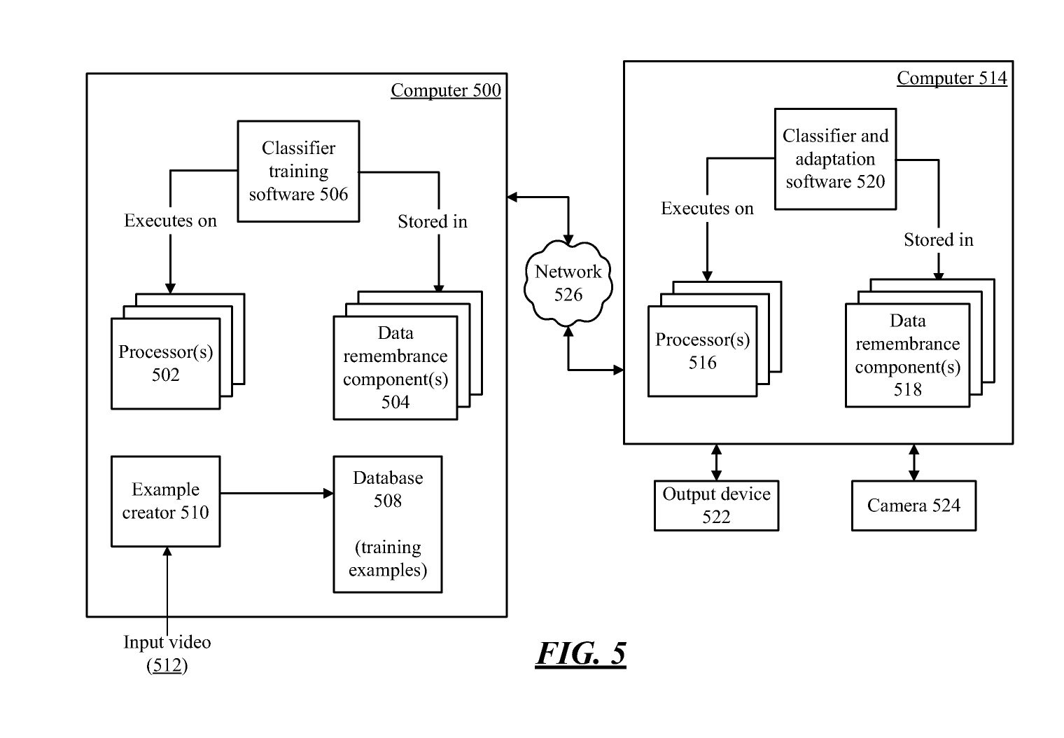

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media.

Software may be stored in the data remembrance component(s) 504, and may execute on the one or more processor(s) 502. An example of such software is classifier training software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as software having instructions to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium.

Computer 500 may have a database 508 of training examples, which may be stored in one or more of data remembrance component(s) 504. Software 506 may have functionality that uses the training examples in database 508 to train a classifier. The examples in database 508 may be provided by any source. In one example, an example creator 510 may create examples based on input video 512, and may store those examples in database 508. Example creator 510 may implement the process shown in FIG. 4, but could implement any process.

In one example environment, computer 500 may be communicatively connected to one or more other devices through network 526. Computer 514, which may be similar in structure to computer 500, is an example of a device that can be connected to computer 500, although other types of devices may also be so connected.

Computer 514 may include one or more processor(s) 516 and one or more data remembrance component(s) 518, which are analogous in structure to the components of the same name in computer 500. Software may be stored in data remembrance component(s) 518, such as classifier and adaptation software 520, which may implement some or all of the functionality described above in connection with FIGS. 1-4, although any software could be used in connection with computer 514. The subject matter described herein may be implemented a software 520 that is stored in data remembrance component(s) 518 and that executes on processor(s) 516. As another example, the subject matter described herein may be implemented as executable instructions that are stored on one or more computer-readable storage media (where the instructions may be stored together on a single medium, or may be distributed across several media).

Computer 514 may comprise, or otherwise use, output device 522 and/or camera 524. Output device 522 may be a monitor, such as a cathode ray tube (CRT) monitor or a liquid crystal display (LCD) monitor, or could be any other type of output device (such as an audio device). Camera 524 may be a video camera, a still camera, or any type of camera that collects images. Camera 524 may be used to collect input for classifier and adaptation software 520, and output device 522 may be used to allow that software to communicate a result to a person, or otherwise to interact with a person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media comprising executable instructions to perform a method, the method comprising:
classifying a first input item based on a first set of parameters that have been determined based on minimization of a first cost function over a set of first examples;
receiving a second example;
calculating a second set of parameters that minimizes a second cost function over said set of first examples and said second example, said second cost function being based on a third cost function that is based (a) on said first cost function, or (b) on a representation of said set of first examples that is smaller in data size than said set of first examples;
generating a label based on a second input item and on said second set of parameters; and
performing an action based on said label.

2. The one or more computer-readable storage media of claim 1, wherein said representation comprises:
a Hessian matrix that is derived from said first cost function and from said set of first examples.

3. The one or more computer-readable storage media of claim 1, wherein said representation comprises a gradient of said first cost function that is derived, in part, from said set of first examples.

4. The one or more computer-readable storage media of claim 1, wherein said third cost function comprises a finite-order Taylor expansion of said first cost function.

5. The one or more computer-readable storage media of claim 1, wherein said second cost function comprises a weighted sum of said third cost function applied to said representation and a fourth cost function applied to said second example.

6. The one or more computer-readable storage media of claim 1, wherein one of said first examples, or said second example, comprises: (a) a content item, and (b) a label of said content item.

7. The one or more computer-readable storage media of claim 1, wherein one of said first examples, or said second example, comprises: (a) a first content item, (b) a second content item, and (c) an indication of whether said first content item and said second content item are to be labeled the same as, or differently from, each other.

8. The one or more computer-readable storage media of claim 1, further comprising:
receiving a first frame and a second frame;
choosing a first window in said first frame;
choosing a second window in said second frame based on a tracking algorithm from said second window and said first window;
determining that said a difference between said first window and said second window does not exceed a threshold according to a distance measure; and
creating a third example that comprises: (a) said first window, (b) said second window, and (c) a positive similarity indication.

9. A method providing a classifier, the method comprising:
calculating a first set of parameters that, when used with the classifier to label a first set of examples, minimizes a first cost function over said first set of examples;
creating a second cost function that is based on said first cost function and a representation of said first set of examples that is smaller than said first set of examples; and
delivering the classifier, said second cost function, a component that minimizes a weighted sum involving said second cost function, and said representation, to an environment in which the classifier will operate.

10. The method of claim 9, wherein said creating of said second cost function comprises:
calculating a gradient of said first cost function that is derived, in part, from said first set of examples, said second cost function comprising said gradient.

11. The method of claim 9, wherein said creating of said second cost function comprises:
calculating a Hessian matrix that is derived from said first cost function and from said first set of examples, said second cost function comprising said Hessian matrix.

12. The method of claim 9, wherein said creating of said second cost function comprises:
deriving a finite-order Taylor expansion from said first cost function, wherein said second cost function comprises said finite-order Taylor expansion.

13. The method of claim 9, wherein said weighted sum further involves a third cost function that is operable to generate a label on an example that is receivable in said environment, wherein either said second cost function, said third cost function, or both said second cost function and said third cost function are multiplied by weights in said weighted sum.

14. The method of claim 9, wherein one of said examples comprises: (a) an image, and (b) a label of said image.

15. The method of claim 9, wherein one of said examples comprises: (a) a first image, (b) a second image, and (c) an indication of whether said first image and said second image are to be labeled the same as, or differently from, each other.

16. A system to classify input, the system comprising:
a camera that collects an input item;
a data remembrance component that stores a first set of parameters;
one or more components that receive said input item, that generate a label of said input item based on said first set of parameters, and that generate a second set of parameters by minimizing a cost function that is based on a representation of a first set of examples from which said first set of parameters is derived, said representation being smaller in data size than said first set of examples; and
an output device through which a result based on said label is communicated to a person.

17. The system of claim 16, wherein said representation comprises:
a gradient of said cost function that is derived from said first set of examples.

18. The system of claim 16, wherein said representation comprises:
a Hessian matrix that is derived from said cost function and from said first set of examples.

19. The system of claim 16, wherein said representation comprises:
a finite-order Taylor expansion of said cost function.

20. The system of claim 16, further comprising:
an example creator that receives a first frame and a second frame and that creates a similarity example that is based on a first window of said first frame, a second window of said second frame, and a histogram distance between said first window and said second window.
